(19) United States
(12) Patent Application Publication
(10) Pub. No.: US 2013/0209603 A1
(43) Pub. Date: Aug. 15, 2013

(54) INJECTION MOLDING MACHINE

(71) Applicant: Hans-Peter Maenner, Freiburg (DE)

(72) Inventor: Hans-Peter Maenner, Freiburg (DE)

(73) Assignee: OTTO MAENNER INNOVATION GMBH, BAHLINGEN (DE)

(21) Appl. No.: 13/878,349

(22) PCT Filed: Oct. 10, 2011
(86) PCT No.: PCT/EP2011/005057

§ 371 Date: Apr. 8, 2013

(30) Foreign Application Priority Data
Oct. 8, 2010 (DE) 10 2010 048 000.2

(51) Int. Cl. B29C 45/04

(52) U.S. Cl. CPC B29C 45/0433
USPC 425/547; 425/556

(57) ABSTRACT

An injection molding machine for producing injection molded parts has an injecting station in which melt can be introduced into a cavity of a tool part. The cavity corresponds to the injection molded part. The injection molding machine has further stations in which the injection molded parts can be treated. The injection molded parts can be transported from one station to another station by way a transporting device. The transporting device has at least one transporting path that connects two stations. The injection molded parts are movable from one station to another station on the transporting path.

The invention relates to an injection molding machine for the manufacture of injection molded parts comprising an injection station for charging melt in a cavity of a mold tool corresponding to the injection molded part, said mold tool having at least a first mold part and a second mold part which can be brought into an open and a closed position, wherein the first mold part has at least one gate runner and the cavity is arranged at least partially in the second mold part, having a cooling station, a separating station for separating and removing the sprue, an ejection station for demolding the molded parts and a transportation means comprising at least one transportation track connecting the stations on the transportation track on which the second mold part, and optionally an injection molded part in the cavity, is movable from one station to another station. Furthermore the invention relates to a mold part for the cold side of a mold tool of an injection molding machine wherein the mold part is transportable along a guide on which the mold part can be connected to a corresponding stationary mold part for the hot side of the mold tool to define a cavity, and can be transported from an injection station to at least one cooling station placed at a distance from the injection station, wherein the mold part for the cold side comprises the following:
a main body made from a first material,
a cavity module made from a second material,
a mold space with a cavity for forming a molded part at the injection station,
a heat dissipation area made of a good heat conducting third material, said heat dissipation area being suited to interact with the cooling station, wherein the heat dissipation area comprises a surface that faces the cooling station when in its operating position and is suited, when in direct thermal contact with a cooling area of the cooling station, to dissipate heat from the cavity module and the mold space to the cooling area,
a connecting part which is detachably connectible to a corresponding connecting part of the injection station for detachably connecting the mold part for the cold side with the mold part for the hot side such that the mold part for cold side containing the molded part is transportable to the cooling station, and
a positioning area for positioning of the mold part for the cold side relative to the injection station and the cooling station.

Such an injection molding machine is known from U.S. Pat. No. 3,973,891. It comprises a plurality of mold tools, which each have three mold parts which can be stacked one above the other, and which define a cavity in the form of a corresponding molded part to be manufactured. The mold parts of each mold tool can be clamped together by a clamping means. The injection molding machine has a separation/assembly device, by means of which the mold tools are separated from each other for removing the molded parts and can be subsequently reassembled for the manufacture of a further molded part. The individual mold parts are delivered by a transportation means first to the separation/assembly device, in order to assemble them there to a mold tool and to clamp it with the clamping means. After this, the mold tool thus obtained is delivered with the help of the transportation means to an injection station at which melt is charged in the cavity. Thus the clamping means holds the mold parts of the mold tool together. Subsequently the mold tool is conveyed, together with the melt located in the cavity, to a cooling station in which the melt solidifies. Following this, the mold tool is delivered again to the separation/assembly device to separate the mold parts from one another, to remove the molded part from the cavity and to remove the sprue from the molded part. If required the above mentioned steps can be repeated in order to manufacture at least one further molded part. The injection molding machine has the disadvantage that the cooling of the mold tool at the cooling station is relatively time consuming. Moreover it is inconvenient that the mold tool has to be reheated after the assembly of the mold parts. The injection molding machine therefore has a correspondingly long cycle time. Also a relatively large amount of energy is needed for the operation of the injection molding machine.

The object of the invention is to provide an injection molding machine which is cost-effective, space-saving and provides for a shorter cycle time. Further, the object is to provide a mold part for the cold side of a mold tool of such an injection molding machine.

This object is solved with reference to the injection molding machine in that the first mold part is stationarily arranged at a machine nozzle and the second mold part, separated from the first mold part, is movable along the transportation track, that the second mold part has a heat dissipation area comprising a good heat conducting material and that the heat dissipation area is thermally contactable with a cooling area of the cooling station such that the cooling area is distant from the injection molded part.

In an advantageous manner, thus it is possible after completion of the injection molding process but before the melt has completely solidified, to open the mold tool and then to transport only the second mold part together with the molded part located inside it to the cooling station. At the cooling station the heat dissipation area of the second mold part is brought into thermal contact with the cooling area of the cooling station in order to cool the second mold part and the molded part located inside it. Because the molded part at the beginning of the cooling process is still relatively soft and deformable, direct contact is avoided between the cooling station or the cooling area and the molded part. The first mold part remains at the machine nozzle and is not cooled. The injection molding machine according to the invention allows the molded part to cool quickly, so that it can then be removed from the second mold part. Because only the second mold part of the mold tool is cooled, the injection molding machine allows an energy saving operation. Moreover, the injection molding machine is space-saving.

As the transportation means comprises at least one transportation track connecting two stations, on which the molded parts can be moved from one station to another, several molded parts can be transported at the same time. Thus, for example, a molded part can be transported from the injection station to a cooling station and at the same time a molded part can be transported from the cooling station to an ejection station.

In a preferred embodiment of the invention, the cooling area comprises a cooling element movable to and from the heat dissipation area, wherein the cooling element can be brought into thermal contact with the heat dissipation area for direct cooling of the second mold part. Thereby the cooling element can planarly contact the heat dissipation area so that the second mold part with the molded part within it can be cooled correspondingly quickly. The cooling element is preferably configured as a cooling plate.

It is advantageous if a heating station is arranged as a further heating station on the transportation track. Here the heating station is arranged in the transport direction downstream of the cooling station so that the second tool part may be preheated before it is positioned at the injection station. Heating of the second mold part has the advantage that melt injected into the cavity during the injection process cools only very slowly. This makes it possible to produce very delicate molded parts. Because the slower that the melt is cooled during the injection molding, the better the shape of the molded part. In the further station configured as a heating station, the relevant tool or the relevant second tool part may be heated in two stages by means of induction. For this purpose the mold part only needs to be positioned in front of the inductor and the induction to be started. Other elements are substantially not required. As the mold part is heated in two stages, it can be preheated in the first stage and heated to the desired final temperature in the second stage. In this way the heating of the mold parts to their final temperature takes place within a considerably shortened cycle time.

It is advantageous for the cooling element to be actively cooled. Thus the second tool part is cooled more quickly. Moreover the cooling element can have correspondingly compact dimensions.

In a preferred embodiment of the invention, the cooling element has at least one coolant channel through which a coolant can flow. It is preferred to use water as a coolant. In an advantageous manner, the cooling of the tool half can thus take place in that a water-cooled aluminum plate is pressed by means of a pneumatic cylinder to the surface of the mold half. This creates a contact cooling.

In an advantageous embodiment of the invention, the cooling element is movable to and from the mold part transversely to the transportation direction of the mold part. The injection molding machine thus allows a simple construction.

Advantageously, the injection molding machine has a pressure device by means of which the cooling element is planarly pressed against the second mold part. Thus the heat can be more quickly dissipated from the second tool part in the cooling area of the cooling station.

In another advantageous embodiment of the invention, the cooling station in the cooling area comprises at least one gas outlet opening, from which a cooling gas can flow out directly to the heat dissipation area. The heat dissipation area can be cooled without having to contact the cooling station. In order to avoid deformation of the molded part, the gas outlet openings are designed so that a direct blowing by the cooling gas of the molded part is avoided.

Furthermore, if the transportation track forms a closed circuit, as is provided in a particular embodiment of the invention, the preheated mold in the heating station may be transported to the injection station again. Due to the simultaneous transport of the tool between the stations, the cycle time of the injection molding machine is clearly reduced. It is merely limited by the longest dwell time of the tool at a station.

Advantageously, the transportation track comprises linear conveyors, which are connected to one another at their ends and each rotated by 90 degrees. The connection of the linear conveyors at their ends is carried out in an advantageous manner by means of rotational drives. Rather than as a linear conveyor, the transportation track could also be designed as a conveyor belt which extends through the processing stations, or passes along the processing stations.

As the transportation track comprises linear conveyors which form a closed circuit, the main elements of the injection molding machine may be arranged inside the transportation track. This has a very beneficial effect on the space requirements of the injection molding machine.

A molded part can be manufactured by means of the injection molding machine according to the invention in the following manner: a mold located in the injection station is closed. Then melt is injected into the cavity of the mold. Subsequently the mold is opened. Thus, the actual injection molding process is complete.

Simultaneously with the injection molding process, a molded part, or the corresponding mold part, located at the cooling station can be cooled at a cooling station which is located outside the injection station. Also simultaneously with the injection molding process, a molded part located at a station which is also arranged outside the injection station, can be separated from the sprue and the sprue can be removed. Furthermore, at a station also arranged outside the injection station, and simultaneously with the injection molding process, a molded part can be demolded from a mold part which is located at the corresponding station. Finally, a mold part, which is located at a heating station, can be heated simultaneously with the injection molding process.

After completion of the injection molding process, the molded part and the second mold part in which the molded part is located, can be transported from the injection station to the cooling station in a transportation step. During the transportation step, the mold part located at the cooling station can be transported at the same time from the cooling station to the station in which the sprue is removed from molded part. In addition, simultaneously with the transportation step, the second mold part, located at the station in which the molded part's sprue is removed, can be transported from this station to the station where the molded part is demolded from the second mold part. Moreover, simultaneously to the transportation step, the mold part located at the station for demolding of the molded parts can be transported from this station to the heating station. Finally, simultaneously to the transportation step, the mold part, which is located in the heating station, can be transported from the heating station to the injection station.

Thus during the transportation step the transportation of all relevant second mold parts from one station to the next station can take place simultaneously. Thus, in the injection molding machine according to the invention, not only a substantially simultaneous operation of the various subprocesses for the manufacture of a molded part can take place but also the transport of the molded part to the different processing stations can take place. This has a very beneficial effect on the cycle time of the injection molding machine.

As a cooling station is available, the time necessary to cool down the molded part such that it can be demolded is considerably reduced. This is particularly noticeable when the molded part and/or the sprue is voluminous.

In a further particular embodiment of the invention, the injection station comprises a centering element for centering the second mold part which is introduced in the injection station. This achieves the advantageous result that the transportation means does not need to position the second mold part very accurately. Therefore the transportation means may be structured correspondingly simply and in a cost-effective way.

The above-mentioned object refers to the mold part for the cold side of a mold tool of an injection molding machine wherein the mold part is transportable along a guide from an injection station at which the mold part can be combined with a corresponding stationary mold part for the hot side of the mold tool to define a cavity to at least one cooling station arranged at a distance from the injection station, said object being solved in that the mold part for the cold side comprises the following:
a main body made from a first material,
a cavity module made from a second material,
a mold space with a cavity for forming a molded part at the injection station,
a heat dissipation area made of a good heat conducting third material, said heat dissipation area being suited to interact with the cooling station, wherein the heat dissipation area comprises a surface that faces the cooling station when in its operating position and is suited, when in direct thermal contact with a cooling area of the cooling station, to dissipate heat from the cavity module and the mold space to the cooling area,
a connecting part which is detachably connectible to a corresponding connecting part of the injection station for detachably connecting the mold part for the cold side with the mold part for the hot side such that the mold part for the cold side containing the molded part is transportable to the cooling station, and
a positioning area for positioning of the mold part for the cold side relative to the injection station and the cooling station.

Then the mold part for the cold side can be transported together with the molded part within it to the cooling station, in order to bring the heat dissipation area of the mold part in thermal contact with the cooling area of the cooling station. In an advantageous manner, it is thus possible that the mold part for the cold side does not need to be permanently connected to the coolant lines or electric supply lines. Thus, the tool part for the cold side can be transported simply from the injection station to the cooling station and optionally to at least one further station.

In a low-cost embodiment of the invention, the second material is the same as the first material.

The first material is preferably highly heat-resistant and is composed in particular of copper, a copper alloy, aluminum, an aluminum alloy and/or ceramic. Thus a rapid cooling of the second mold part at the cooling station is permitted.

In a low-cost embodiment of the invention, the connecting part is a mechanical connecting part. In this case, the connecting part can comprise, for example, one or more tension bolts or similar tensioning or clamping elements.

But it is also conceivable that the connecting part has at least one permanent magnet and/or electromagnet, or is designed such that it can interact magnetically with such a permanent magnet and/or electromagnet.

In another embodiment of the invention, the connecting part comprises means for generating a negative pressure. The means can comprise, for example, hollow spaces, in particular in a working cylinder, which are connected to a vacuum pump.

Further details, features and advantages of the present invention will become apparent from the following description of a particular embodiment with reference to the drawings.

It is shown in:

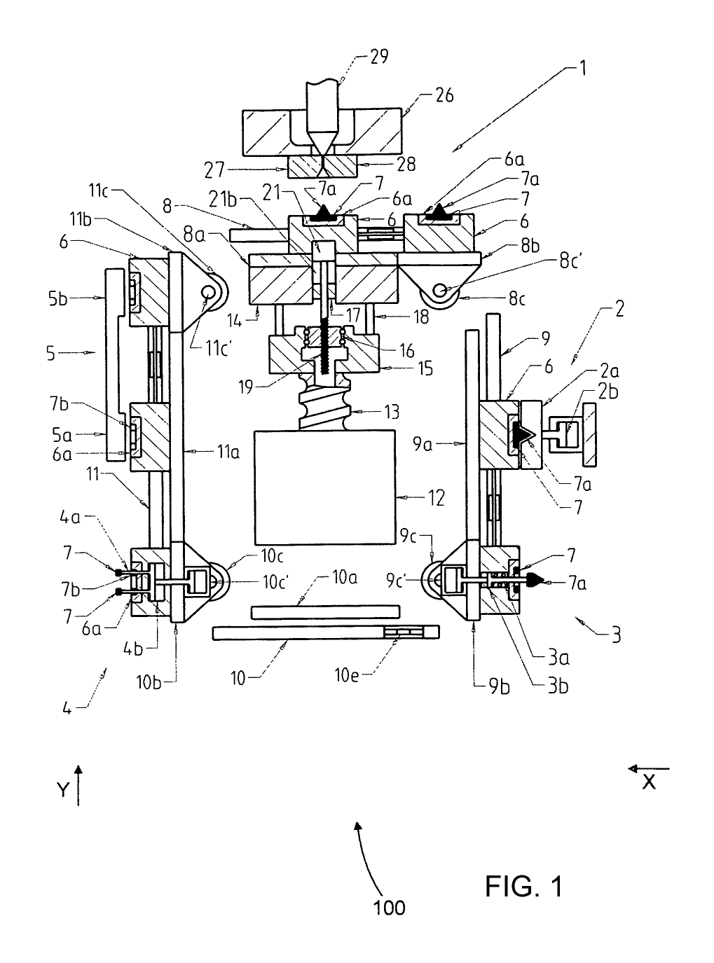

FIG. 1 a schematic representation of an injection molding machine according to the invention in plan view,

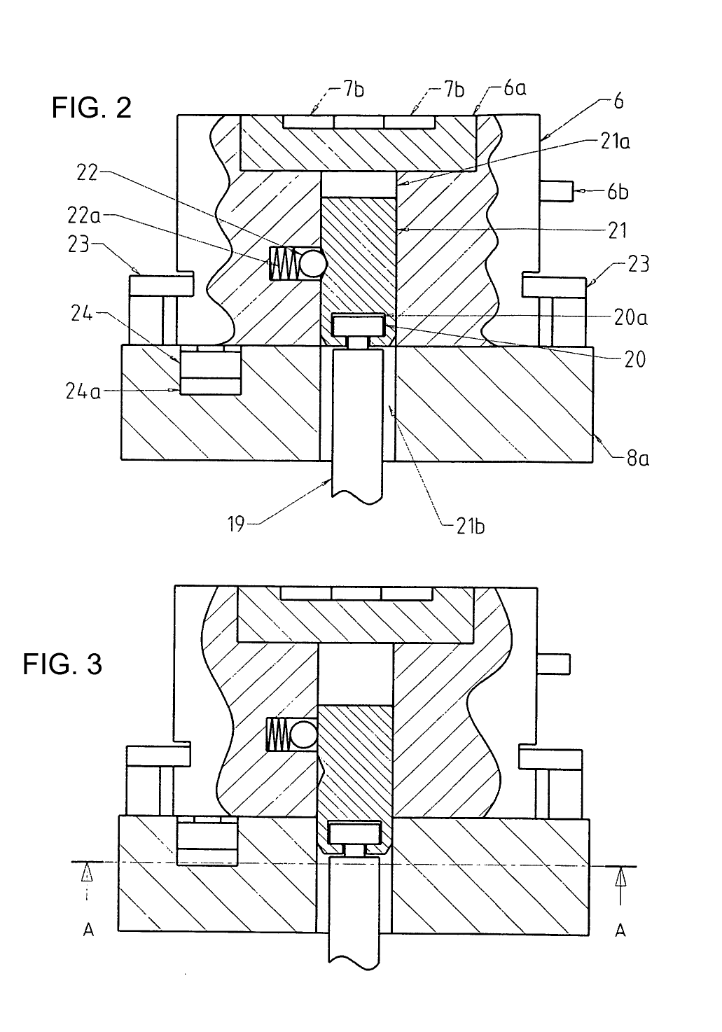

FIG. 2 an enlarged detail of FIG. 1 relating to the centering function of the injection station in a first state, viewed in the direction shown by an arrow X,

FIG. 3 the enlarged detail shown in FIG. 2 in a second state, viewed in the direction shown by the arrow X,

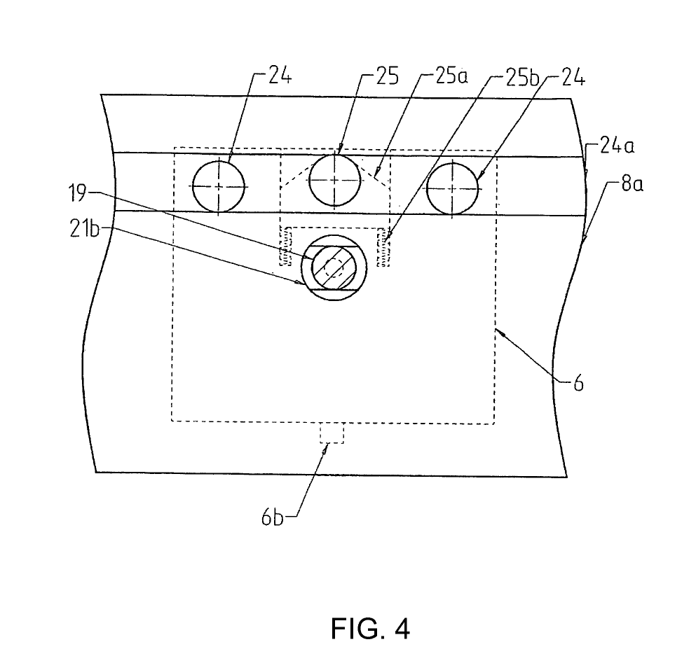

FIG. 4 a section view along the section lines AA in FIG. 3, viewed in the direction shown by an arrow Y and

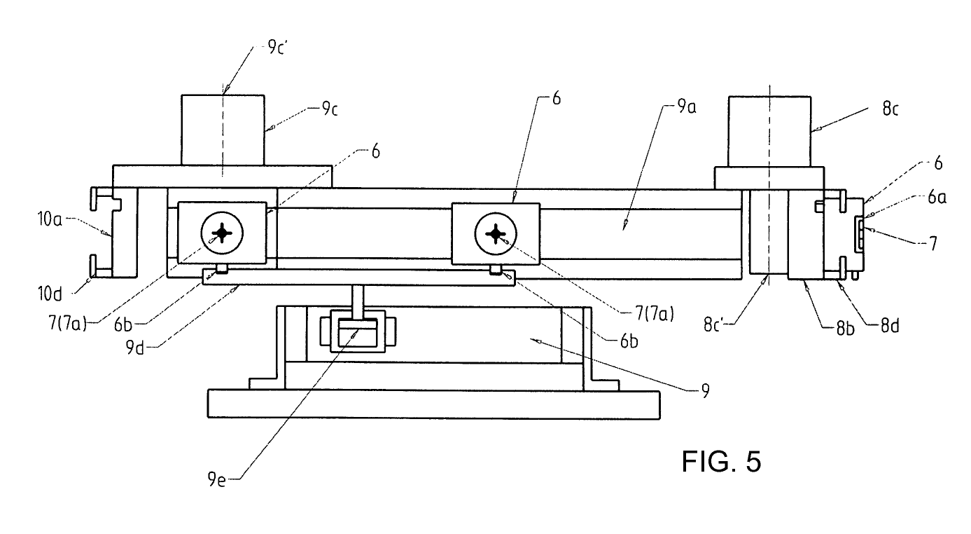

FIG. 5 elements concerning the transportation means of the injection molding machine shown in FIG. 1, viewed in the direction shown by the arrow X.

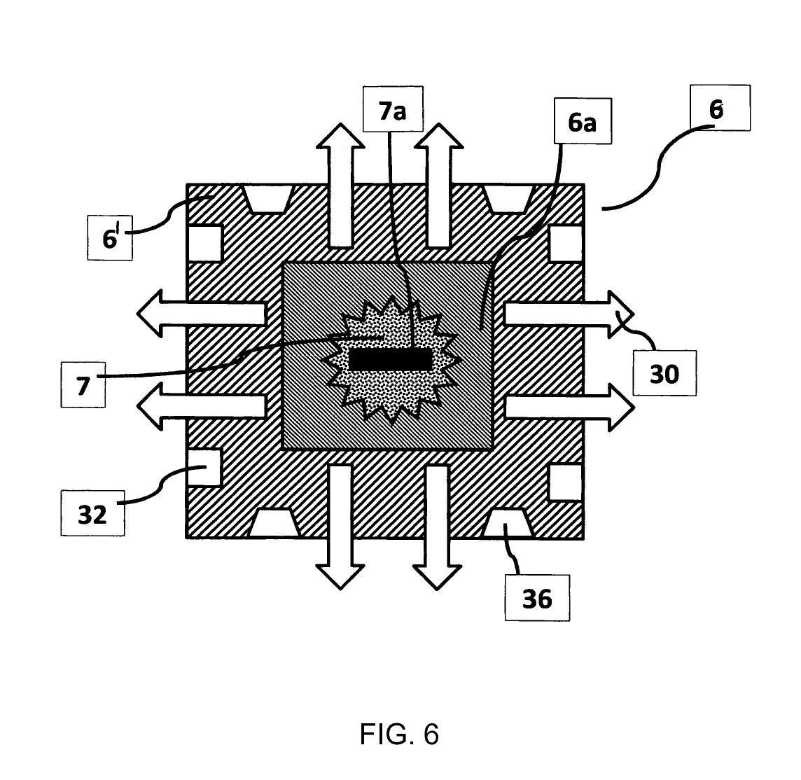

FIG. 6 a side view of a first application example of a mold part for the cold side of a mold tool,

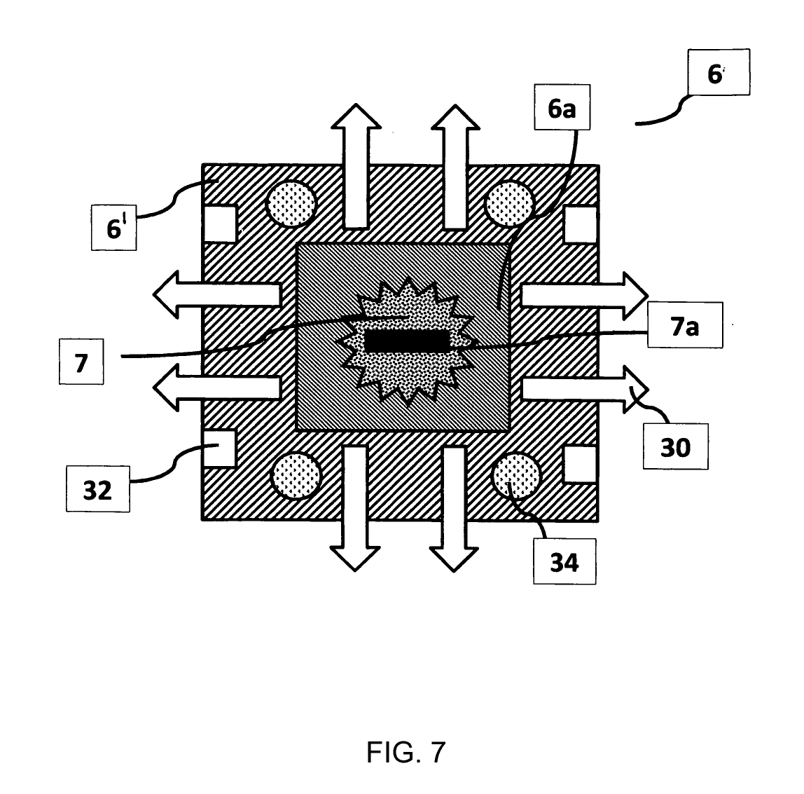

FIG. 7 a side view of a second application example of a mold part for the cold side of the mold tool,

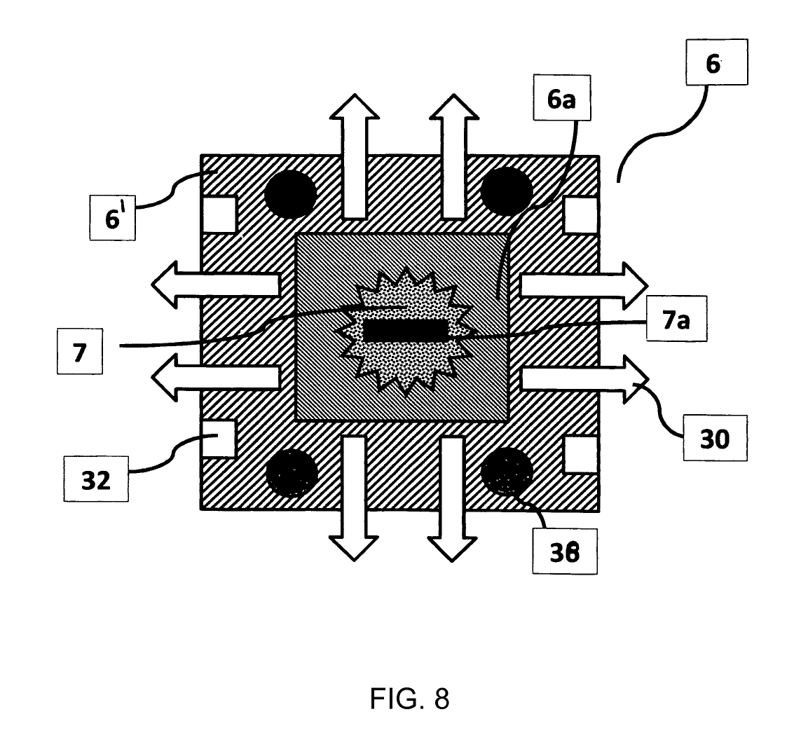

FIG. 8 a side view of a third application example of the mold part for the cold side of a mold tool, and

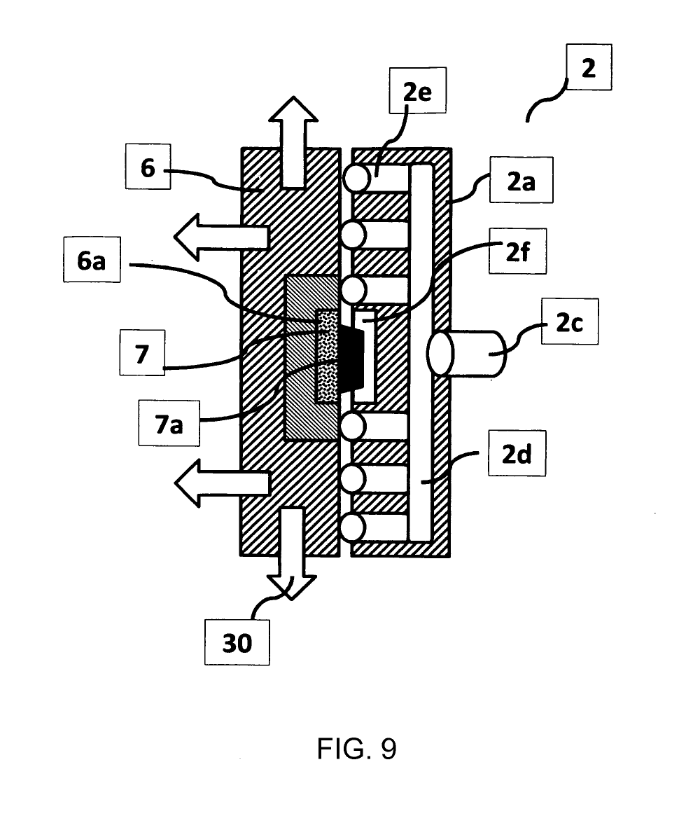

FIG. 9 a cross section through a mold part for the cold side of the mold tool, positioned at a cooling station, wherein the cooling station has gas outlet openings for a cooling gas.

As can be seen in FIG. 1, a mold tool is arranged in an injection station 1 of an injection molding machine 100, said mold tool comprising a stationary first mold part 28 connected to a machine nozzle 29 and an adjustable second mold part 6. The mold parts 6, 28 are each configured as mold halves. They can be moved towards and away from each other and can be brought into an open position shown in FIG. 1 as well as into a closed position.

The movable second mold part 6 has a recess in which a cavity module 6a is located, which has a cavity 7b. The movement of the second mold part 6 is effected by means of a ball screw spindle 13 driven by a drive system 12. The ball screw spindle 13 displaces a pressure plate 15, which is connected via pressure bolts 18 to a displaceable mold mounting platen 14. A slide rail 8a is arranged on the opposite side of the pressure bolts 18 on the movable mold mounting platen 14, on which the second mold part 6 is arranged in a laterally movable way.

Opposite the second mold part 6, a non-movable first mold part 28 is arranged, which is also arranged on a non-movable mold mounting platen 26. The non-movable first mold part 28 has a gate runner 27, into which melt is chargeable by means of a machine nozzle 29.

When the second mold part 6 is pressed onto the first mold part 28 by means of the ball screw spindle 13, the cavity 7b which is formed in the impression 6a is closed. Then melt flowing through gate runner 27 can fill the entire space of the cavity 7b under pressure.

In FIG. 1, at the right side of the first slide rail 8a, a first rotatable slide rail 8b is arranged which can be rotated by 90 degrees about an axis 8c′ by means of a rotational drive 8c. This allows the first rotatable slide rail 8b which is in the position shown in FIG. 1, in which it is aligned with the first slide rail 8a, to be brought into a position in which it is aligned with a second slide rail 9a, which is disposed at an angle of about 90 degrees to the first slide rail 8a. A second mold part 6 disposed on the first slide rail 8a can thus be transported by moving initially to the first rotatable slide rail 8b and, after rotating the first rotatable slide rail 8b, can be transported on the second slide rail 9a.

At the second slide rail 9a another station is arranged which is designed as a cooling station 2. The cooling station 2 has a water-cooled aluminum plate 2a which can be pressed onto a second mold part 6 located at the cooling station 2 via a pneumatic cylinder 2b. By the contact-cooling generated in this way, the movable second mold part 6 and in particular the molded part 7 located in the second mold part 6 are cooled together with the sprue 7a.

In FIG. 1, a second rotatable slide rail 9b is arranged below the second slide rail 9a, and which can be rotated by 90 degrees about an axis 9c′ by means of a rotational drive 9c. This allows the second rotatable slide rail 9b which is in the position shown in FIG. 1, in which it is aligned with the second slide rail 9a, to be brought into a position in which it is aligned with a third slide rail 10a, which is disposed at an angle of about 90 degrees to the second slide rail 9a. A movable mold part 6 disposed on the second slide rail 9a can thus be transported by moving initially to the second rotatable slide rail 9b and, after rotating the second rotatable slide rail 9b, can be transported on the second slide rail 10a.

At the second rotatable slide rail 9b a further station 3 is arranged, which is designed as a separating station 3 in which the sprue 7a of the molded part 7 is removed and ejected. The removal is done by means of a plunger 3a, which is operated by a pneumatic cylinder 3b.

As further illustrated in FIG. 1, at the left side the third slide rail 10a a fourth slide rail 11a is arranged at an angle of about 90 degrees to the third slide rail 10a. In FIG. 1 a third rotatable slide rail 10b is arranged at a lower end of the fourth slide rail 11a, which can be rotated by 90 degrees about an axis 10c′ by means of a rotational drive 10c. This allows the third rotatable slide rail 10b which is in the position shown in FIG. 1, in which it is aligned with the fourth slide rail 11a, to be brought into a position in which it is aligned with a fourth slide rail 10a. A second mold part 6 disposed on the third slide rail 10a can thus be transported by moving initially to the third rotatable slide rail 10b and, after rotating the third rotatable slide rail 10b, can be transported on the fourth slide rail 11a.

An ejection station 4 is arranged as a further station at the third rotatable slide rail 10b, in which the molded parts 7 are demolded from the cavity 7b, wherein they are still arranged in the cavity 7b of a second mold part 6 when at station 4. The demolding is done by plungers 4a, which are operated by a pneumatic cylinder 4b.

A further station designed as a heating station 5 is arranged at the fourth slide rail 11a. The heating station 5 comprises an inductor, by means of which a second mold part 6 located in a first section 5a of the heating station 5 is preheated to a first temperature. A second mold part 6 located in a second section 5b of the heating station 5 is heated to its desired final temperature.

In FIG. 1, a fourth rotatable slide rail 11b is arranged above the fourth slide rail 11a. The fourth rotatable slide rail 11b can be rotated by 90 degrees about an axis 11c′ by means of a rotational drive 11c. This allows the fourth rotatable slide rail 11b which is in the position shown in FIG. 1, in which it is aligned with the fourth slide rail 11a, to be brought into a position in which it is aligned with a first slide rail 8a, which is disposed at an angle of about 90 degrees to the fourth slide rail 11a. A second mold part 6 disposed on the fourth slide rail 11a can thus be transported by moving initially to the fourth rotatable slide rail 11b and, after rotating the fourth rotatable slide rail 11b, can be transported on the first slide rail 8a.

The respective second mold part 6 can then be transported to the injection station 1 on the first slide rail 8a. When the second mold part 6 has reached its position in the injection station 1, a centering bolt 21 arranged in a recess 21a in the second mold part 6 is pulled into an opening 21b located in the first slide rail 8a. Thus it is ensured that the second mold part 6 is arranged in an exact position in the injection station 1 required for carrying out the injection molding process. The centering pin 21 is connected to a second ball screw spindle 19 which is driven by a ball-bearing drive 16. The second ball screw 19 is supported by a bearing 17 in the movable mold mounting platen 14. The structure of the centering device is shown more clearly in FIGS. 2 and 3.

As can be seen in FIG. 2, the centering pin 21 is arranged in the recess 21a of the movable mold part 6, in which a plunger is normally disposed for the demolding of the molded part. The centering pin 21 has a T-groove-shaped recess 20a, in which is arranged a corresponding T-shaped head 20 of a ball screw spindle 19. The ball screw spindle 19 is disposed such that the head 20 enters the T-groove-shaped recess 20a of the centering pin 21 during the displacement of the second mold part 6.

Furthermore, the centering pin 21 has a recess formed at its circumference, with which a ball 22 engages. Thereby, the centering bolt 21 is held in its position when the second mold part 6 is not located on a slide rail. Ball 22 is pressed into the recess by means of a force produced by a spring 22a.

To facilitate the introduction of the centering pin 21 into the opening 21b of the first slide rail 8a, the centering bolt 21 has suitable chamfering at its end facing the recess 21b.

In FIG. 3, the centering pin 21 is partially disposed in the opening 21b. In this way, the second mold part 6 is located in an exact position. Moreover FIG. 3 corresponds with FIG. 2. It was deemed unnecessary to add reference numerals.

At the first slide rail 8a, guiding elements 23 are arranged which engage in corresponding guiding grooves at the second mold part 6. In addition, the first slide rail 8a has a support groove 24a, wherein consecutively arranged rollers 24, 25 fastened at the second mold part 6 lie against the walls of the support groove 24a. The second mold part 6 is supported on the first slide rail 8a by means of the rollers 24, 25.

As can be seen in particular in FIG. 4, for improved support, the roller 25, which is arranged between two outer rollers 24, is secured to a slide 25a, on which the force of two springs 25b acts. The spring force is such that the center roller 25 is pressed against the upper wall of the groove 24a and the outer rollers 24 are pressed against the lower wall of the groove 24a.

The other slide rails 8b, 9a, 9b, 10a, 10b, 11a, 11b are constructed substantially in the same way, so there is no need for a detailed description of these slide rails.

The lateral movement of the second mold part 6 is effected by means of rodless pneumatic cylinders 8, 9, 10, 11, whereby the first pneumatic cylinder 8 carries out the transport of second mold parts 6 arranged on the first slide rail 8a, the second pneumatic cylinder 9 carries out the transport of second mold parts 6 arranged on the second slide rail 9a, the third pneumatic cylinder 10 carries out the transport of second mold parts 6 arranged on the third slide rail 10a and the fourth pneumatic cylinder 11 carries out the transport of second mold parts 6 arranged on the fourth slide rail 11a. The functionality of the lateral movement is exemplified on the arrangement shown in FIG. 5 of the second pneumatic cylinder 9 and the second slide rail 9a.

As can be seen in FIG. 5, a short stroke cylinder 9e, whose piston rod is connected to a rail 9d, is arranged at the driving pin of the second pneumatic cylinder 9. Rail 9d has recesses, into which projections 6b, which are arranged on the second mold parts 6, engage. When projections 6b engage in the recesses of the rail 9d, the corresponding second mold parts can be moved laterally by means of the second rodless pneumatic cylinder 9.

In the position shown in FIG. 5, the second mold part 6 arranged on the left side is located at the station 3, in which the sprue 7a is discharged and the movable mold part 6 shown on the right side in FIG. 5 is at the cooling station 2. Due to clarity the stations 2 and 3 are not shown.

Once the second mold parts 6 are arranged at stations 2 and 3, preferably during the time when the processes carried out at stations 2 and 3 are performed, the short-stroke cylinders 9e can be actuated such that the rail 9d lowers, whereby the projections 6b of the second mold parts 6 are no longer engaged with the rail 9d. Thereupon, the second pneumatic cylinder 9 is operated such that the short stroke cylinder 9e and thereby the rail 9d are displaced to the right.

Before or simultaneously with the actuation of the second pneumatic cylinder 9, the first rotatable slide rail 8b is actuated such that it is aligned with the second slide rail 9a. Thereby a second mold part 6 which is arranged on the first rotatable slide 8b reaches a position in which the recess of rail 9d which is shown on the right side in FIG. 5 is located below the projection 6b of the respective movable mold part 6. Then the rail recess 9d shown on the left side in FIG. 5 is arranged below the projection 6b of the second mold part 6 which is arranged at the cooling station 2.

By operation of the short stroke cylinder 9e the rail 9d is moved upward so that the projections 6b of both of the corresponding second mold parts 6 engage in the recesses of the rail 9d.

After the sprue 7a is ejected at station 3, the second rotatable slide rail 9d is rotated such that it is aligned with the third slide rail 10a. When this happens, the second mold part 6 arranged on the second rotatable rail 9b is moved from the second rotatable slide rail 9b to the third slide rail 10a and the second rotatable slide rail 9b is rotated back into its starting position.

After this is the case and the cooling of the corresponding second mold part 6 is performed at the cooling station 2, the second pneumatic cylinder 9 is operated such that the second mold part 6 located at the cooling station 2 is moved to station 3, in which the sprue 7a is ejected, and the second mold part 6 which is located on the first rotatable slide rail 8b is moved to the cooling station 2. Thereupon the processes at stations 2 and 3 are performed again and the above described process is repeated.

The above described transport is carried out in an almost unchanged manner at the first slide rail 8a, and at the fourth slide rail 11a. The transport of the second mold part 6 on the third slide rail 10a differs from the above-described transport in that only one second mold part 6 is transported at a time. That is, an element corresponding to rail 9d is not needed for the transport of the second mold parts 6 on the third slide rail 10. The driving pin 10e of the third pneumatic cylinder 10 is in an operative connection with the projection 6b of the respective second mold part 6 after an appropriate movement. This allows, by operating of the third pneumatic cylinder 10, the movement of a second mold part 6 arranged at the second rotatable slide rail 9b via the third slide rail 10a directly to the third rotatable slide rail 10b.

By means of the arrangement of the rails 8a, 8b, 9a, 9b, 10a, 10b, 11a, 11b shown in FIG. 1, a closed circuit is provided, on which second mold parts 6 can be transported throughout. Very advantageously, the most important components of the injection molding machine 100, such as for example the clamping unit may be located within the closed circuit. This enables a very compact construction, which requires little space.

In FIG. 6 it can be seen that the movable second mold part 6, for the cold side of the mold tool, comprises an approximately cuboid shaped main body 6′ made from a first material. A cavity module 6a from a second material is arranged in the main body 6′, wherein said cavity module comprises a mold space with the cavity 7b for forming the molded part 7 at the injection station 1.

The second mold part 6 has a heat dissipation area made of a good heat conducting material. The heat dissipation area has a surface which faces the cooling station 2, when the second mold part 6 is positioned at the cooling station. Here the surface stays in direct thermal contact with a cooling area of the cooling station 2. Thus heat from the cavity module 6a and the mold space is dissipated to the cooling area.

Moreover the second mold part 6 shown in FIG. 6 has a plurality of connecting parts 36 configured as mechanical clamps, wherein the clamps are releasably connectible to a corresponding connecting part of the injection station, which connecting part is not shown in greater detail in the drawing.

Furthermore the second mold part 6 has a positioning area 32, by means of which the mold part for the cold side is positionable relative to the injection station 1 and the cooling station 2. As can be seen in FIG. 1, the pneumatic cylinder 8 engages with the positioning area.

In the second mold part 6 shown in FIG. 7, the connecting parts 34 are configured as a magnetic clamping device. Otherwise the construction of this mold part 6 corresponds to that in FIG. 6.

As can be seen in FIG. 8, the connecting parts 38 can also be configured as a vacuum clamping device.

It can be seen in FIG. 9 that the cooling station 2 in the cooling area can comprise a cooling plate 2a with gas outlet openings 2e, from which cooling air can flow out directly to the heat dissipation area of the second mold part 6. The gas outlet openings 2e are connected via channels 2d to an entry 2c for the cooling air. To protect the molded part 7 and the sprue 7a from the cooling air, the cooling plate 2a comprises an interior 2f facing the cavity 7b in which the sprue 7a engages.

1-18. (canceled)

19. An injection molding machine for the manufacture of injection molded parts, comprising:
an injection station for charging melt into a cavity of a mold tool corresponding in form to the injection molded part, the mold tool having at least a first mold part and a second mold part, to be brought into an open position and a closed position;
said first mold part having at least one gate runner and being disposed at a machine nozzle;
said cavity being formed, at least partially, in said second mold part;
a cooling station disposed separate from said injection station and an ejection station disposed separate from said injection station for demolding the molded parts;
a transportation device having a transportation track connecting said injecting station, said cooling station, and said ejection station along said transportation track;
wherein said mold is openable after completion of an injection molding process and said second mold part, separated from said first mold part and carrying the molded part, is movable along said transportation track and to said cooling station;
said transportation device for moving said second mold part further including:
linear conveyors having ends, and rotational drives connecting said ends of said linear conveyors to each other; and
slide rails on which said second mold parts are arranged laterally movably, and guiding elements disposed at said slide rails and engaging in corresponding guiding grooves of said second mold parts.

20. The injection molding machine according to claim 19, wherein said guiding elements are arranged at said slide rails such that they guide the second mold part on two opposite sides.

21. The injection molding machine according to claim 19, wherein said transport device further comprises rails for moving said second mold part laterally, said rails having recesses into which projections formed on said second mold part are engageable.

22. The injection molding machine according to claim 19, wherein said second mold part has a heat dissipation area comprising heat conducting material and said heat dissipation area is thermally contactable with a cooling area of said cooling station such that said cooling area is distal from the injection molded part.

23. The injection molding machine according to claim 22, wherein said cooling area comprises a cooling element movable transversely to a transportation direction of said mold part to and from the heat dissipation area, wherein said cooling element can be brought into thermal contact with the heat dissipation area for direct cooling of said second mold part.

24. The injection molding machine according to claim 23, wherein said cooling element is an actively cooled element.

25. The injection molding machine according to claim 24, wherein said cooling element has at least one coolant channel through which a coolant can flow.

26. The injection molding machine according to claim 23, which further comprises a pressing device for planarly pressing said cooling element to said second mold part.

27. The injection molding machine according to claim 19, wherein said cooling station comprises at least one gas outlet opening in a cooling area thereof, from which a cooling gas can flow out directly to a heat dissipation area.

28. The injection molding machine according to claim 19, which further comprises a separating station arranged along said transportation track and configured for separating and removing sprue.

29. The injection molding machine according to claim 19, which further comprises a heating station arranged along said transportation track.

30. The injection molding machine according to claim 19, wherein said transportation track is formed in a closed circuit.

31. The injection molding machine according to claim 30, which comprises a clamping unit disposed within said closed circuit.

32. The injection molding machine according to claim 19, wherein said injection station comprises a positioning element for locating said second mold part, introduced in said injection station, relative to said first mold part.

33. A mold part for a cold side of a mold tool of an injection molding machine, wherein the mold part is transportable along a guide and the mold part can be connected to a corresponding mold part arranged at a machine nozzle for a hot side of the mold tool to define a cavity, and the mold part can be transported from an injection station to at least one cooling station disposed at a distance from the injection station, and wherein the mold part for the cold side of the mold tool comprises:
a main body made from a first material;
a cavity module made from a second material;
a mold space with a cavity for forming a molded part at the injection station;
a heat dissipation area made of heat conducting material, said heat dissipation area being configured to interact with the cooling station, said heat dissipation area having a surface facing the cooling station when in the operating position and being configured, when in direct thermal contact with a cooling area of the cooling station, to dissipate heat from the cavity module and the mold space to the cooling area.

34. The mold part for the cold side according to claim 33, which comprises a connecting part which is detachably connectable to a corresponding connecting part of the injection station, for detachably connecting the mold part for the cold side with the mold part for the hot side such that the mold part for the cold side containing the molded part is transportable to the cooling station.

35. The mold part for the cold side according to claim 33, which comprises a positioning area for positioning the mold part for the cold side relative to the injection station and the cooling station.

36. The mold part for the cold side according to claim 34, wherein said connecting part is a mechanical connecting part or the connecting part has at least one magnet (permanent and/or electromagnet), or is configured to interact magnetically with a magnet (permanent and/or electromagnet), or said connecting part comprises means for generating a negative pressure.

37. An apparatus for the manufacture of injection molded parts, comprising:
an injection station for charging melt into a cavity of a mold corresponding to the injection molded part;
a fixed mold half and a plurality of moveable mold halves, wherein said mold halves are transportable independently from respectively other mold halves;
a demolding station remote from said injection station and configured to receive said movable mold halves and eject the molded parts therefrom;
at least one further station, wherein the injection molded parts and/or said mold halves are processed;
tracks for guiding said mold halves and for transporting said mold halves from one station to another station; and
independently movable rails disposed to engage said mold halves and for moving said mold halves.

38. The injection molding machine according to claim 19, wherein said linear conveyors are arranged at an angle of 90 degrees to each other.
